(19) United States
(12) Patent Application Publication
(10) Pub. No.: US 2007/0135186 A1
(43) Pub. Date: Jun. 14, 2007

(54) Wireless earphone with retractable microphone

(76) Inventor: Tung Yuan Lee, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,855

(22) Filed: Dec. 7, 2006

Related U.S. Application Data
(63) Continuation-in-part of application No. 11/298,465, filed on Dec. 12, 2005.

(51) Int. Cl. H04M 1/00

(52) U.S. Cl. 455/575.2

(57) ABSTRACT

A wireless earphone with retractable microphone includes a sound producing set, to which a sound receiving set with a push button is retractably and slidably connected. The sound producing set internally includes a guiding mechanism having a sliding element and a limiter mounted thereto. The limiter is separably engaged with the sliding element under control of the push button on the sound receiving set. The sound producing set includes a bottom and an upper case connected to each other for receiving a circuit unit and the guiding mechanism therebetween. The guiding mechanism is located near a first opening on a top of the upper case. When the push button is depressed, the limiter is moved downward to separate from the sliding element, allowing the sound receiving set to automatically slide outward and enable a communication system. When the sound receiving set is retracted, the communication is disconnected.

### REFERENCE TO RELATED APPLICATIONS

This patent application is being filed as a Continuation-in-Part of patent application Ser. No. 11/298,465, filed 12 Dec. 2005, and currently pending.

### BACKGROUND OF THE INVENTION

1. Field of the Invention

The present invention relates to a wireless earphone with retractable microphone, and more particularly to a wireless earphone having a microphone that may be slid from a retracted to an extended position to enable a communication system simply by depressing a push button, and slid back to the retracted position again to disenable the communication system.

2. Description of the Prior Art

Earphones and microphones are frequently used in stereophonic and communication systems. Conventional earphones/microphones have different forms for wearing over a user's head, hanging on a user's ear, or plugging in a user's ear. The earphone/microphone for wearing over the user's head is most frequently seen in home stereos, and usually provides better sound spectrum. The plug-type earphone/microphone is often used with a hand-free receiver for a mobile phone or a walkman. With the advancement in technologies, earphones have developed from the conventional wired types to the wireless types. Currently very popular wireless earphones include infrared earphones, radio frequency (RF) earphones, and Bluetooth earphones. However, Bluetooth earphone is the first bidirectional wireless earphone available in the market.

The currently available Bluetooth earphone has unique and miniaturized design. As a result, the microphone included in the earphone is located at a point somewhat distant from the user's mouth. In this case, the microphone must be toned to have a high sensitivity in receiving sound. However, the microphone would also receive more noises at the same time, and requires more complicate circuits to enhance the sound receiving sensitivity thereof, resulting in higher manufacturing cost and selling price of the Bluetooth earphone.

It is therefore tried by the inventor to develop a wireless earphone with retractable microphone to overcome the drawbacks existed in the Bluetooth earphone. The wireless earphone is provided with a push button. When the push button is depressed, a microphone provided on the earphone automatically slides outward to enable voice communication at high sensitivity. And, when the microphone is slid back to an original position, the voice communication is automatically disconnected. Therefore, the wireless earphone is very suitable for use with a Bluetooth mobile phone with music playing function.

### SUMMARY OF THE INVENTION

A primary object of the present invention is to provide a wireless earphone with a retractable microphone, in which a push button may be easily depressed to slide the microphone to an extended position to enable a communication system, and the extended microphone may be slid back to an original retracted position to disconnect the communication system.

To achieve the above and other objects, the wireless earphone with retractable microphone according to the present invention includes a sound receiving set having a push button, and a sound producing set, to which the sound receiving set is retractably and slidably mounted. The sound producing set includes a guiding mechanism, to which a sliding element and a limiter are mounted, the limiter being normally engaged with the sliding element, and separable from the sliding element when the push button on the sound receiving set is depressed; a circuit unit; a lower case; and an upper case connected to and closed onto a top of the lower case to define an inner space between the upper and the lower case for receiving the guiding mechanism and the circuit unit therein. The upper case is provided at a top with a first opening, and the guiding mechanism is located in the inner space at one side near the first opening.

Preferably, the guiding mechanism includes a base board, and at least one guiding shaft mounted above the base board. The base board is symmetrically provided at two opposite ends with at least one ear each, and each of the ears has a shaft hole. And, the at least one guide shaft is mounted above the base board with two ends fixedly supported in the shaft holes of the ears. The sliding element is mounted on the at least one guide shaft to slide to and fro along the guide shaft, and includes a fastener hooked to the sound receiving set. The sliding element is provided at a front side with a guiding section for guiding the limiter when the limiter is moved downward by the depressed push button. The limiter is fixedly mounted below the base board with a portion of the limiter upward projected from a round hole formed on the base board.

Preferably, the sound receiving set includes a sliding assembly, which is mounted in the first opening to movably connect to a top of the guiding mechanism. The sliding assembly includes a base being provided at a front end with a first recess, and at a rear end with a through hole for a push head of the push button to downward extend therethrough; a circuit board being mounted on the base; and a cover plate being connected to the base via at least one pair of fasteners provided on the base, and having a receiver element mounted thereto. The receiver element is received in the first recess on the base, so as to locate at a front end of the sound receiving set for receiving sound conveniently. The base is provided at the rear end with a hook for engaging with a fastener on the sliding element to thereby connect the sliding assembly to the guiding mechanism.

The wireless earphone with retractable microphone according to the present invention can be easily operated by depressing the push button to extend the microphone to enable a communication system, and sliding the extended microphone back to an original retracted position to automatically disconnect the communication system.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a wireless earphone with retractable microphone according to a preferred embodiment of the present invention, wherein the retractable microphone is in an extended position for use;

FIG. 2 is an exploded view of FIG. 1;

FIGS. 3 and 3A are top and sectioned side views, respectively, of the wireless earphone of FIG. 1 with the retractable microphone in a retracted position;

FIGS. 4 and 4A are top and sectioned side views, respectively, of the wireless earphone of FIG. 1 with the retractable microphone in an extended position.

### DETAILED DESCRIPTION OF THE INVENTION

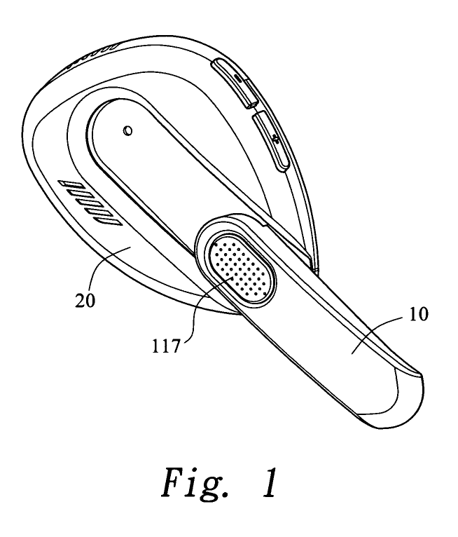

Please refer to FIG. 1 that is an assembled perspective view of a wireless earphone with retractable microphone according to a preferred embodiment of the present invention. As shown, the wireless earphone of the present invention mainly includes a sound receiving set 10 and a sound producing set 20. The sound receiving set 10 is retractably and slidably mounted on the sound producing set 20.

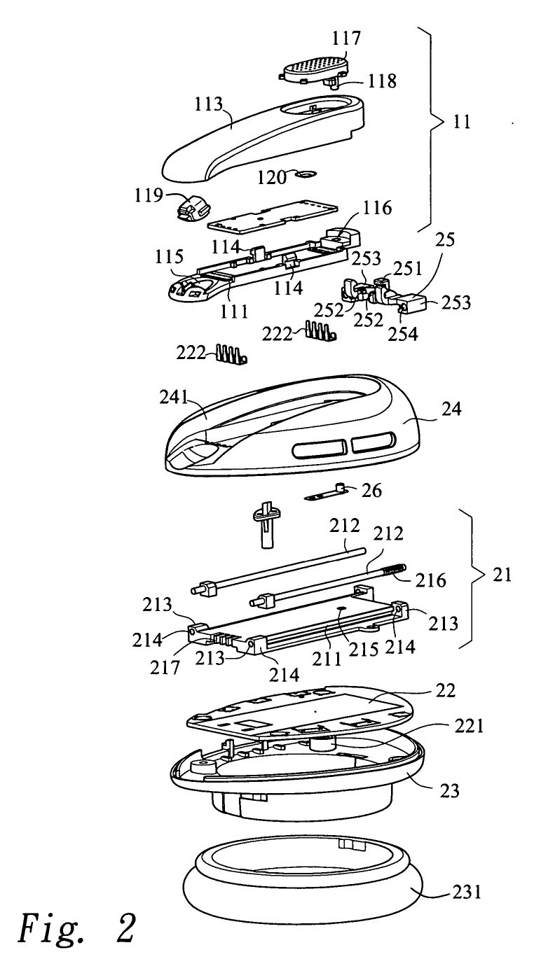

Please refer to FIG. 2 that is an exploded view of the wireless earphone of FIG. 1. The sound producing set 20 is a generally known loudspeaker, and includes a guiding mechanism 21, a circuit unit 22, a lower case 23, and an upper case 24. The upper case 24 is connected to and closes a top of the lower case 23, so that an inner space is defined between the two cases 23, 24 for receiving the guiding mechanism 21 and the circuit unit 22 therein. The upper case 24 is provided at a predetermined position with a first opening 241. The guiding mechanism 21 is located in the inner space at one side near the first opening 241 to enable convenient connection of the guiding mechanism 21 to a sliding assembly 11 of the sound receiving set 10.

The guiding mechanism 21 includes a base board 211, on which at least one guide shaft 212 is provided. At least two ears 213 are symmetrically formed at two opposite ends of the base board 211. Each of the ears 213 has a shaft hole 214 formed thereon, so that the at least one guide shaft 212 is located above the base board 211 with two ends fixedly supported in the shaft holes 214 of the two ears 213. In the illustrated preferred embodiment of the present invention, there are two pairs of ears 213 symmetrically provided at two opposite ends of the base board 211 for fixedly supporting two guide shafts 212 thereon.

To enable stable sliding of the sound receiving set 10 on and relative to the sound producing set 20, a sliding element 25 is mounted on the two guide shafts 212 to slide to and fro along the guide shafts 212. The sliding element 25 includes a fastener 251 hooked to the sound receiving set 10. Therefore, when the sliding element 25 slides along the guide shafts 212, the sound receiving set 10 is brought to slide at the same time. The sliding element 25 is provided at a front side with a guiding section 252 for guiding a limiter 26. The limiter 26 is fixedly mounted below the base board 211 with a portion upward projected from a round hole 215 formed on the base board 211.

Each of the guide shafts 212 has an elastic element 216 mounted thereon to normally press against a rear side of the sliding element 25, so that the sliding element 25 may be pushed by an elastic force of the elastic elements 216 to slide forward along the guide shafts 212. Two lateral ends of the sliding element 25 are formed into two ears 253, each of which has a shaft hole 254. The sliding element 25 is slidably mounted on the guide shafts 212 by extending the guide shafts 212 through the two shaft holes 254.

The circuit unit 22 is mounted in the lower case 23 to locate below the guiding mechanism 21. The circuit unit 22 includes a loudspeaker 221 for producing sound. A protective cover 231 may be provided to enclose the lower case 23, so that the sound producing set 20 is protected against damage and dust.

The base board 211 is provided at an end with a plurality of partitioned holes 217, via which contacts 222 on the circuit unit 22 are extended to contact with or separate from a circuit board 112 in the sliding assembly 11 of the sound receiving set 10.

When the circuit unit 22 and the guiding mechanism 21 have been mounted in the lower case 23, the upper case 24 is connected to the top of the lower case 23 to complete the sound producing set 20.

At this point, the sound receiving set 10 may be mounted in the first opening 241 of the upper case 24. The sound receiving set 10 includes a sliding assembly 11, which is mounted in the first opening 241 to movably connect to a top of the guiding mechanism 21. The sliding assembly 11 includes a base 111, a circuit board 112, and a cover plate 113. The base 111 is provided at predetermined positions with at least one pair of fasteners 114 for hooking to the cover plate 113. The base 111 is provided at a front end with a first recess 115, and at a rear end with a through hole 116. The circuit board 112 is mounted on the base 111. The cover plate 113 is provided at a predetermined position with a receiver element 119, which is a microphone. The cover plate 113 is also provided at another predetermined position with a push button 117 having a downward protruded push head 118. The push head 118 is downward extended through the through hole 116 at the rear end of the base 111 to contact with the limiter 26 partially upward projected from the round hole 215 on the base board 211. When the push button 117 is depressed, the push head 118 pushes the limiter 26 downward to move away from the sliding element 25, so that the sliding element 25 is allowed to slide forward under the elastic force of the elastic elements 216 and therefore brings the sound receiving set 10 to a position forward extended from the sound producing set 20. And, when the push button 117 is released, it is elastically pushed upward by a pressure spring leaf 120 to an original elevated position.

The receiver element 119 is received in the first recess 115 on the base 111 so as to locate at a front end of the sound receiving set 10 to enable convenient receiving of sound via the receiver element 119. The base 111 is provided at the rear end with a hook (not shown) for engaging with the fastener 251 on the sliding element 25 to thereby connect the sliding assembly 11 to the guiding mechanism 21.

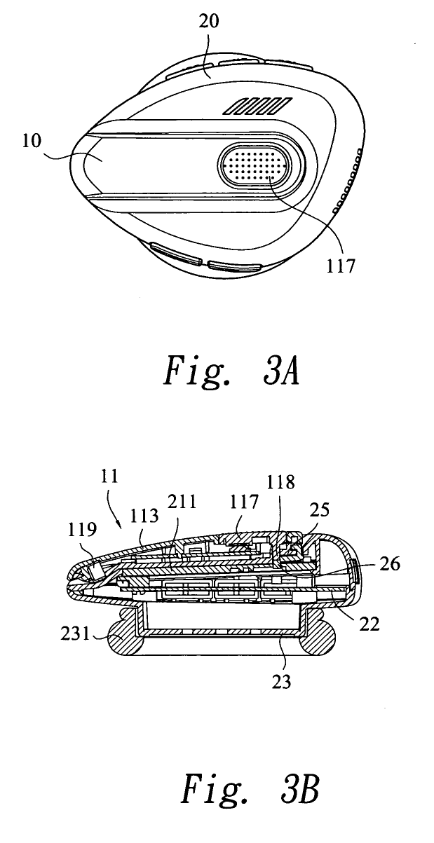

FIGS. 3A and 3B are top and sectioned side views, respectively, of the wireless earphone of the present invention with the sound receiving set 10 in a retracted position. Please refer to FIGS. 3A and 3B. When it is desired for the sound receiving set 10 to locate at a retracted position in the first opening 241 of the sound producing set 20, simply slide the sound receiving set 10 rearward along the guiding mechanism 21 until the sliding element 25 connected to the sound receiving set 10 is located at a position behind the limiter 26. At this point, the limiter 26 would go back into the guiding section 252 of the sliding element 25 and stops the sliding element 25 from sliding forward under the elastic force of the elastic elements 216. As a result, the sound receiving set 10 is held to the retracted position. The guiding section 252 of the sliding element 25 includes a pair of protrusions located at the front side of the sliding element 25, and each of the two protrusions may be in the form of a hooked block.

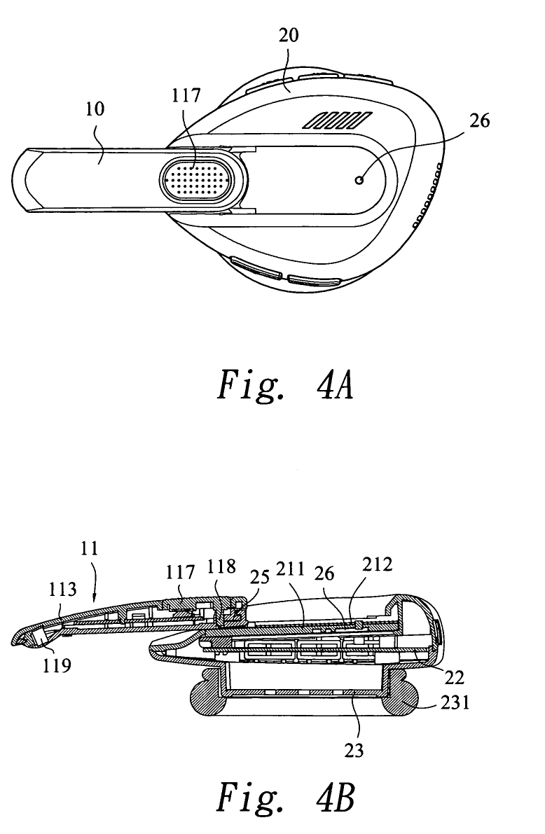

FIGS. 4A and 4B are top and sectioned side views, respectively, of the wireless earphone of the present invention with the sound receiving set 10 in an extended position. Please refer to FIGS. 4A and 4B. When it is desired for the sound receiving set 10 to forward extend from the first opening 241 of the sound producing set 20, simply depress the push button 117 to compress the pressure spring leaf 120. At this point, the push head 118 of the push button 117 is moved downward through the through hole 116 to push the limiter 26 in the guiding section 252 to locate below the sliding element 25, allowing the sliding element 25 to separate from the limiter 26. At this point, the sliding element 25 is pushed forward by the elastic elements 216 to slide along the guide shafts 212, and thereby brings the sound receiving set 10 to forward extend from the sound producing set 20. To retract the extended sound receiving set 10, simply repeat the movements previously described with reference to FIGS. 3A and 3B.

The wireless earphone with retractable microphone having the above arrangements may be easily assembled and conveniently stored. The retractable sound receiving set 10 or the microphone 119 may be easily extended from an original retracted position to enable a communication system simply by depressing the push button 117 on the sound receiving set 10, and be retracted to disenable the communication system simply by sliding the sound receiving set 10 from the extended position back to the retracted position.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wireless earphone with retractable microphone, comprising:
a sound receiving set provided with a push button; and
a sound producing set, to which the sound receiving set is retractably and slidably assembled; the sound producing set including:
a guiding mechanism, to which a sliding element and a limiter are mounted;
the limiter being normally engaged with the sliding element, and being separable from the sliding element when the push button on the sound receiving set is depressed;
a circuit unit;
a lower case; and
an upper case connected to and closed onto a top of the lower case to define an inner space between the upper and the lower case for receiving the guiding mechanism and the circuit unit therein; the upper case being provided at a top with a first opening, and the guiding mechanism being located in the inner space at one side near the first opening.

2. The wireless earphone with retractable microphone as claimed in claim 1, wherein the guiding mechanism includes a base board, and at least one guiding shaft mounted above the base board; the base board being symmetrically provided at two opposite ends with at least one ear each, and each of the ears having a shaft hole; and the at least one guide shaft being mounted above the base board with two ends fixedly supported in the shaft holes of the ears.

3. The wireless earphone with retractable microphone as claimed in claim 2, wherein the sliding element is mounted on the at least one guide shaft to slide to and fro along the guide shaft, and includes a fastener hooked to the sound receiving set.

4. The wireless earphone with retractable microphone as claimed in claim 3, wherein the sliding element is provided at a front side with a guiding section for guiding the limiter when the limiter is moved downward by the depressed push button; and wherein the limiter is fixedly mounted below the base board with a portion of the limiter upward projected from a round hole formed on the base board.

5. The wireless earphone with retractable microphone as claimed in claim 4, wherein the at least one guide shaft has an elastic element mounted thereon to normally press against a rear side of the sliding element, so that the sliding element is pushed by an elastic force of the elastic elements to slide forward along the at least one guide shaft.

6. The wireless earphone with retractable microphone as claimed in claim 1, wherein the guiding mechanism is located above the circuit unit in the inner space defined between the upper and the lower case.

7. The wireless earphone with retractable microphone as claimed in claim 1, wherein the circuit unit includes a loudspeaker for producing sound.

8. The wireless earphone with retractable microphone as claimed in claim 1, wherein the lower case is enclosed with a protective cover.

9. The wireless earphone with retractable microphone as claimed in claim 2, wherein the base board is provided at an end with a plurality of partitioned holes, via which contacts on the circuit unit are extended to contact with or separate from a circuit board in a sliding assembly of the sound receiving set.

10. The wireless earphone with retractable microphone as claimed in claim 1, wherein the sound receiving set is mounted in the first opening on the upper case of the sound producing set.

11. The wireless earphone with retractable microphone as claimed in claim 1, wherein the sound receiving set includes a sliding assembly, which is mounted in the first opening to movably connect to a top of the guiding mechanism.

12. The wireless earphone with retractable microphone as claimed in claim 11, wherein the sliding assembly includes:
a base being provided at a front end with a first recess, and at a rear end with a through hole for a push head of the push button to downward extend therethrough;
a circuit board being mounted on the base; and
a cover plate being connected to the base via at least one pair of fasteners provided on the base, and having a receiver element mounted thereto.

13. The wireless earphone with retractable microphone as claimed in claim 12, wherein the push button in a depressed state is pushed back to an original elevated position by a pressure spring leaf.

14. The wireless earphone with retractable microphone as claimed in claim 12, wherein the receiver element is a microphone.

15. The wireless earphone with retractable microphone as claimed in claim 12, wherein the receiver element is received in the first recess of the base, so as to locate at a front end of the sound receiving set to enable convenient receiving of sound.

16. The wireless earphone with retractable microphone as claimed in claim 12, wherein the base is provided at the rear end with a hook for engaging with a fastener on the sliding element to thereby connect the sliding assembly to the guiding mechanism.
